(19) United States
(12) Patent Application Publication
(10) Pub. No.: US 2007/0229151 A1
(43) Pub. Date: Oct. 4, 2007

(54) Simple VDS Matching Circuit

(76) Inventors: Luthuli E. Dake, McKinney, TX (US); Rex M. Teggatz, Sachse, TX (US); Shanmuganand Chellamuthu, Richardson, TX (US)

Correspondence Address: TEXAS INSTRUMENTS INCORPORATED, P O BOX 655474, M/S 3999, DALLAS, TX, 75265, US

(21) Appl. No.: 11/694,081

(22) Filed: Mar. 30, 2007

Related U.S. Application Data
(60) Provisional application No. 60/787,354, filed on Mar. 30, 2006.

(51) Int. Cl. G05F 1/10

(52) U.S. Cl. 327/543

(57) ABSTRACT

The voltage matching circuit includes: a first branch including a first transistor; a second branch including a second transistor; and a cascaded level shifter coupled between the first and second branches to match a voltage on the first transistor with a voltage on the second transistor.

### CLAIM OF PRIORITY

This application claims priority under 35 U.S.C. 119(e)(1) to U.S. Provisional Application No. 60/787,354 (TI-61492PS) filed Mar. 30, 2006.

### FIELD OF THE INVENTION

The present invention relates to electronic circuitry and, in particular, to a voltage matching circuit.

### BACKGROUND OF THE INVENTION

A basic prior art Vds matching circuit, shown in FIG. 1, uses device 18 (including amplifier A1) for matching. For clarity purposes, the Vds mismatch between main FET 20 and sense FET 22 is designated by ΔVds (voltage difference between nodes D1 and D2). The prior art device of FIG. 1 is accurate and has low input voltage headroom, but is a complicated solution compared to the present invention.

The prior art device of FIG. 2 provides a simple solution (current mirror 30), but has a higher input voltage headroom requirement than the present invention.

The prior art device of FIG. 3 provides an accurate, low input voltage headroom solution using device 40, but is not as simple as the present invention.

The prior art device of FIG. 4 provides a simple, low input voltage headroom solution using device 50, but is less accurate than the present invention.

### SUMMARY OF THE INVENTION

A voltage matching circuit includes: a first branch including a first transistor; a second branch including a second transistor; and a cascaded level shifter coupled between the first and second branches to match a voltage on the first transistor with a voltage on the second transistor.

### BRIEF DESCRIPTION OF THE DRAWINGS

In the drawings:

FIGS. 1-4 are circuit diagrams of prior art Vds matching circuits;

FIG. 5 is a circuit diagram of a preferred embodiment Vds matching circuit using a cascaded level shifter;

FIG. 6 is a circuit diagram of a prior art Vds matching circuit for a common gate PMOS differential pair in a high voltage sense amp application;

FIG. 7 is a circuit diagram of the preferred embodiment Vds matching circuit used for a common gate PMOS differential pair in a high voltage sense amp application.

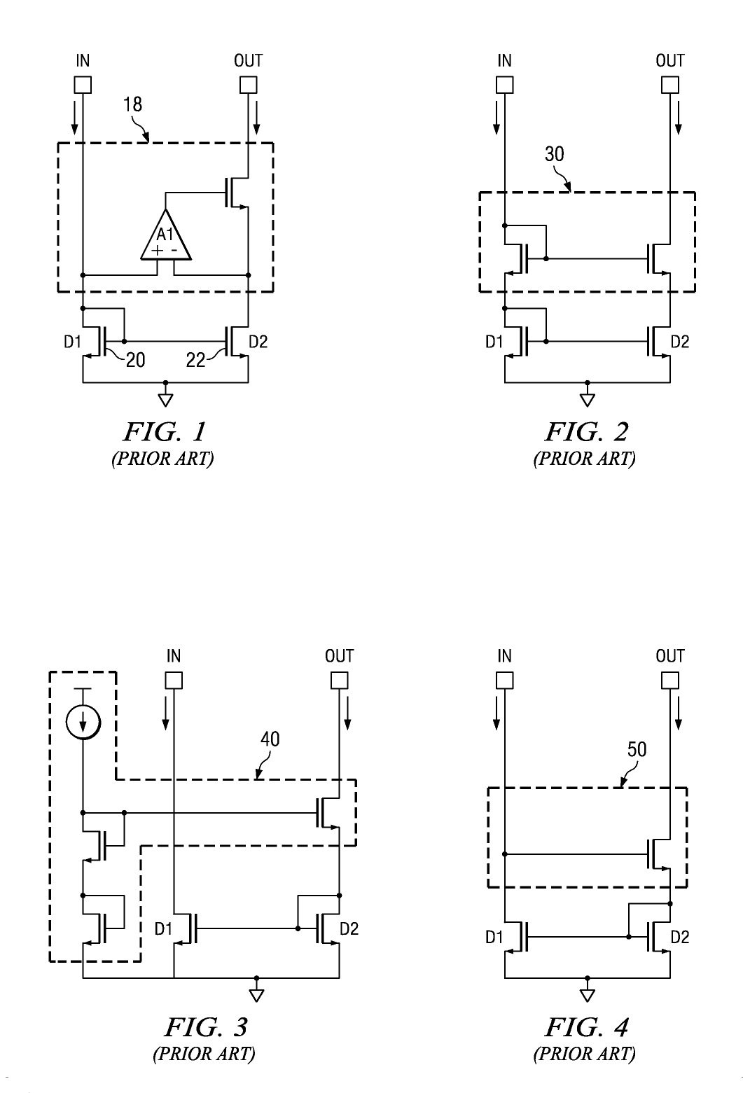

### DETAILED DESCRIPTION OF PREFERRED EMBODIMENTS

A Vds matching circuit, according to the present invention, is used to match Vds of PMOS or NMOS pairs, used in current mirrors or common gate differential pairs. It is especially usefully in high voltage and current applications due to improved area efficiency.

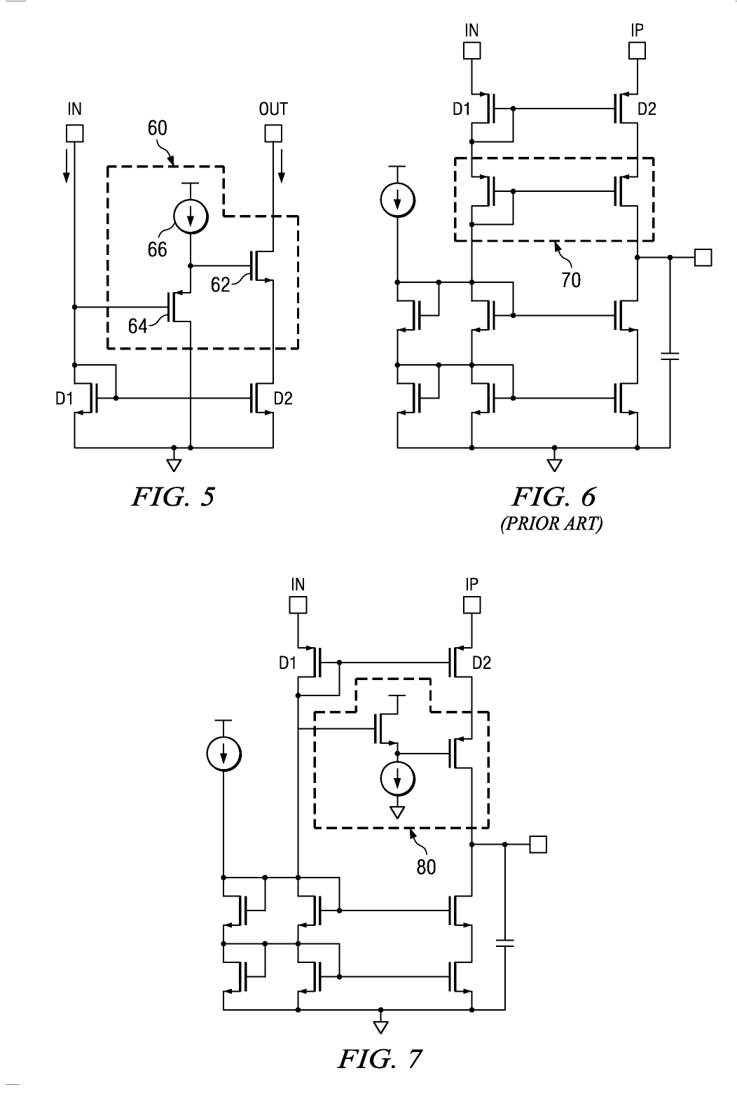

A preferred embodiment Vds matching circuit, shown in FIG. 5, uses a cascaded NMOS and PMOS level shifter 60 to cancel Vds mismatch at nodes D1 and D2. PMOS 64 is used as a PMOS source follower that steps up the Vds voltage at node D1. NMOS 62 is used as an NMOS source follower that steps down its input voltage to match the stepped up voltage of PMOS follower 64. The current source 66 is used to bias the level shifter. Most prior art solutions use same channel FETS. The preferred embodiment device of FIG. 5 provides a simple and versatile solution with reduced headroom requirement and reasonable accuracy. For large current mirror ratios, the preferred embodiment also provides better area efficiency.

FIG. 6 shows a prior art current mirror topology 70 used to match Vds of a common gate PMOS differential pair in a high voltage sense amp application. FIG. 7 shows the preferred embodiment topology 80 used to match Vds of a common gate PMOS differential pair in a high voltage sense amp application.

While this invention has been described with reference to an illustrative embodiment, this description is not intended to be construed in a limiting sense. Various modifications and combinations of the illustrative embodiment, as well as other embodiments of the invention, will be apparent to persons skilled in the art upon reference to the description. It is therefore intended that the appended claims encompass any such modifications or embodiments.

What is claimed is:

1. A voltage matching circuit comprising:
a first branch including a first transistor;
a second branch including a second transistor;
a cascaded level shifter coupled between the first and second branches to match a voltage on the first transistor with a voltage on the second transistor.

2. The circuit of claim 1 wherein the cascaded level shifter is a cascaded NMOS and PMOS level shifter.

3. The circuit of claim 1 wherein the cascaded level shifter comprises two source followers.

4. The circuit of claim 1 wherein the cascaded level shifter comprises a PMOS source follower and an NMOS source follower.

5. The circuit of claim 3 further comprising a biasing current source coupled to the source followers.

6. The circuit of claim 1 wherein the cascaded level shifter comprises:
a first source follower having an input coupled to the first branch; and
a second source follower having an input coupled to an output of the first source follower, and coupled to the second branch.

7. The circuit of claim 6 wherein the second source follower has an opposite polarity of the first source follower.

8. A voltage matching circuit comprising:
a first transistor;
a second transistor having a gate coupled to a gate of the first transistor;
a cascaded level shifter coupled between the first and second transistors for matching a voltage on the first transistor with a voltage on the second transistor.

9. The circuit of claim 8 wherein the level shifter comprises:
a first source follower having an input coupled to the first transistor; and
a second source follower having an input coupled to the first source follower, and coupled to the second transistor.

10. The circuit of claim 1 wherein the level shifter comprises:
a first source follower transistor having a control node coupled to the first transistor;
a second source follower transistor having a control node coupled to an output of the first source follower transistor, and an output coupled to the second transistor.

11. The circuit of claim 10 further comprising a biasing current source coupled to the first source follower transistor.
